(19) United States
(12) Patent Application Publication
(10) Pub. No.: US 2009/0049741 A1
(43) Pub. Date: Feb. 26, 2009

(54) BIODIESEL PURIFICATION METHOD AND SYSTEM

(75) Inventor: Alfred Moser, Perchtoldsdorf (AT)

Correspondence Address: YOUNG & THOMPSON, 209 Madison Street, Suite 500, ALEXANDRIA, VA, 22314, US

(73) Assignee: BIODIESEL ENGINEERING LIMITED, Larnaca (CY)

(21) Appl. No.: 12/094,210

(22) PCT Filed: Nov. 16, 2006
(86) PCT No.: PCT/AT2006/000470

§ 371 Date: Sep. 10, 2008

(30) Foreign Application Priority Data
Nov. 18, 2005 (EP) 05025201.4

(51) Int. Cl. C10L 5/44; C10L 1/02; B01D 15/00; B01D 21/00

(52) U.S. Cl. 44/590; 210/219; 210/195.3; 210/195.1; 44/634

(57) ABSTRACT

According to the invention, unpurified biodiesel is brought in contact with cellulose-containing material by continuously and/or discontinuously mixing the same in order to eliminate the glycerin and catalyst residues, such as potassium soaps, accumulated during the production of the biodiesel. A system for carrying out said method comprises an agitated sedimentation tank (1) with a conduit (4,5) for delivering purified biodiesel into the agitated sedimentation tank (1) and a conveying device (6) for feeding cellulose-containing material into the agitated sedimentation tank (1). A drive unit (51) for an agitator (50) is disposed in the agitated sedimentation tank (1). A conduit (16, 20) extends from the agitated sedimentation tank (1) to at least one static sedimentation tank (2, 3). A valve (13) via which solid matter can be discharged from the agitated sedimentation tank (1) is mounted in the area of the bottom of the agitated sedimentation tank (1).

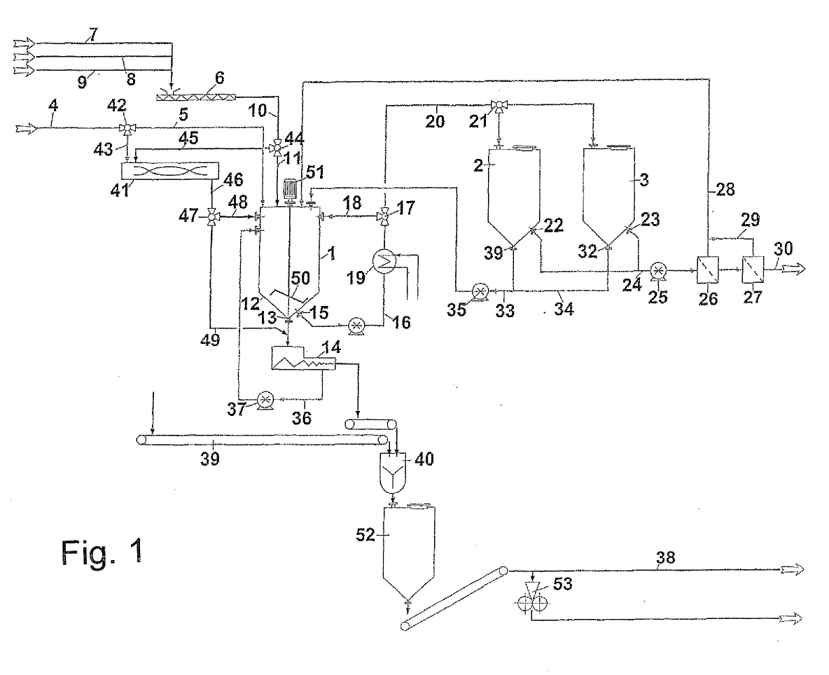

The invention relates to a process for purification of biodiesel. The invention furthermore relates to a system for executing this process and fuels which are obtained as solids by this purification process.

Biodiesel is a fuel with properties similar to diesel fuel and is however obtained among others from renewable raw materials such as vegetable oil. Furthermore biodiesel can be obtained from waste materials of the food industry, such as residues of cooking oils. Chemically biodiesel is a fatty acid methyl ester which is produced from fats and oils in a catalytic transesterification reaction with roughly 10% methanol. Suitable catalysts are mainly potassium hydroxide, sodium hydroxide and alcoholates. During transesterification, at normal pressure and temperatures around 60° C. the ester bonds of the triglycerides of the vegetable oil or edible fat are separated and the fatty acids are then esterified with methanol. Then the glycerin which forms and the catalyst residues present, such as potassium soaps, must be separated from the biodiesel. In doing so it is necessary to also use acid additives, such as phosphoric acid, for removing the alkali potassium soaps which are dissolved in water. This yields environmentally harmful acid waste water in the purification process.

The invention is intended to remedy this.

Therefore, as claimed in the invention a purification process for biodiesel is suggested which is characterized in that the biodiesel is brought into contact with cellose-containing substances.

Preferably this takes place by continuous or discontinuous mixing of the parent substances. Parent substances include not only raw biodiesel, but also cellulose-containing substances such as wood, preferably beechwood. In order to be able to prepare different surfaces of cellulose-containing containing material here, it can be used in the form of shavings and/or dust in different particle sizes. Furthermore, bleaching earth can be added as an adsorption aid during mixing of the components.

Preferred embodiments of the invention are the subject matter of the dependent claims.

Other features and advantages of the invention will become apparent from the following description of one preferred embodiment of the invention in conjunction with the attached drawings.

The drawings show essentially an agitated sedimentation tank 1, two static sedimentation tanks 2, 3, and devices for making use of the solids obtained in the process. In the first process segment raw biodiesel is delivered to the agitated sedimentation tank 1 via a line 4, 5. Cellulose-containing material such as wood shavings 7 and sawdust 8, and if necessary bleaching earth 9 as the adsorption aid, are supplied to a conveyor device 6 and are delivered to the agitated sedimentation tank 1 via a line 10, 11.

The stirring mechanism 50 is operated by a drive 51 at intervals so that intimate intermixing of the biodiesel in raw form and the cellulose-containing material and the bleaching earth is ensured during mixing. In the static stage of the stirring mechanism, dictated by the addition of the bleaching earth as the adsorption agent, relatively rapid settling of the solids in the form of cellulose-containing material which at least partially adheres to the bleaching earth takes place. The solids which have settled on the bottom 12 of the agitated sedimentation tank 1 are withdrawn from the agitated sedimentation tank 1 via a valve 13 and are delivered to a pressing means 14, for example a screen belt press. The biodiesel which has already been purified beforehand and which however is still mixed with suspended matter is withdrawn via a valve 15 which can likewise be located in the region of the bottom 12, and a line 16 in which there is a delivery pump 17. In order to prolong the total residence time of the biodiesel, the withdrawn biodiesel can be returned entirely or partially to the agitated sedimentation tank 1 via a valve 17 and a line 18.

In the line 16 there can furthermore be a heating means 19 in order to keep the temperature of the biodiesel in the agitated sedimentation tank 1 at a given temperature level, preferably about 60° C. At this elevated temperature and with further mixing the adsorption forces or physicochemical forces between the biodiesel and the cellulose-containing material are increased.

The purified biodiesel which is largely free of suspended parts is supplied following the valve 17 via a line 20 and a valve 21 in alternation to the two static sedimentation tanks 2, 3 in which the remaining suspended particles can settle. The completely purified biodiesel is withdrawn via valves 22, 23 from the static sedimentation tanks 2, 3 and is supplied via a collecting line 24 and a pump to two filter stages 26 and 27. The solid-containing fractions of the two filter stages 26, 27 are returned via lines 28, 29 to the agitated sedimentation tank 1. The completely purified biodiesel is routed via the line 30 to a tank.

In the static sedimentation tanks 2, 3 the suspended substances which are still present settle on the bottom and are then returned to the agitated sedimentation tank 1 via valves 31, 32 and lines 33, 34 and the pump 35. The biodiesel which has been pressed out of the pressing means 14 is again likewise supplied to the agitated sedimentation tank 1 via a line 36 using a pump 37.

The solid from which the biodiesel has been largely removed is delivered from the pressing means 14 to a buffer tank 52 and then either to a pressing or a pelletizing means 53 or in the form of a largely loose bed via a conveyor means 38 to a storehouse, silo or the like.

It has been found that these solids are best suited as fuels since they have good heating value when for example beechwood is used as the cellulose-containing material. Furthermore this CO is neutral and thus environmentally compatible. The process as claimed in the invention is economical of costs and energy in that the purified or prepurified biodiesel filtrate is kept in circulation until it is largely free of solids and suspended particles. This can be duplicated at various locations of the process by sampling.

If necessary the solid from the pressing means 14 can be mixed with other combustible substances and further processed. The other substances can be for example oil cake, for example from rape, soy or sunflowers, which is supplied via the conveyor means 39 and to a mixer 40, mixed with the solid. Wood waste can of course likewise be added.

In addition to the agitated sedimentation tank 1 there can also be a mixing device 41 which is connected upstream of the agitated sedimentation tank 1 in the process sequence. The mixing device 41 can be for example a continuously or discontinuously operating mixing and conveying worm to which raw biodiesel is supplied from the line 4 via a valve 42 and a line 43 and the mixture of the cellulose-containing material and bleaching earth is supplied from the line 10 via a valve 44 and a line 45. In this mixing device 41 the biodiesel can already react with the cellulose-containing material. In order to improve the reaction, the mixing device 41 can have successive sections in which mixing alternates with only delivery, not the absence of mixing.

The mixture of biodiesel, cellulose-containing material and bleaching earth which emerges from the mixing device is supplied via a line 46, a valve 47 and a line 48 to the agitated sedimentation tank 1. Only at the end of operation or when operation is interrupted is the valve 47 switched in order to supply residual amounts from the mixing device 41 via a line 49 directly to the pressing means 14.

1. Process for purification of biodiesel, characterized in that the raw biodiesel is brought into contact with cellulose-containing material.

2. Process as claimed in claim 1, wherein the raw biodiesel is brought into contact with the cellulose-containing material with continuous and/or discontinuous mixing.

3. Process as claimed in claim 1, wherein the cellulose-containing material has wood shavings and/or sawdust.

4. Process as claimed in claim 1, wherein the cellulose-containing material has beechwood.

5. Process as claimed in claim 1, wherein bleaching earth as the adsorption agent is added to the cellulose-containing material.

6. Process as claimed in claim 5, wherein wood shavings in an amount of 0.1 to 2.5% by weight, sawdust in an amount from 0.1 to 3.0% by weight and bleaching earth in an amount from 0.05 to 1.0% by weight relative to the amount of raw biodiesel are added to the biodiesel.

7. Process as claimed in claim 1, wherein the solid-containing biodiesel is mixed at a temperature of roughly 60° C.

8. Process as claimed in claim 1, wherein the cellulose-containing material and optionally bleaching earth settle in an agitated sedimentation tank (1).

9. Process as claimed in claim 1, wherein the biodiesel is then subjected to further separation from the cellulose-containing material and optionally the bleaching earth.

10. Process as claimed in claim 1, wherein the cellulose-containing material and optionally the bleaching earth are withdrawn from the purification process and supplied to pressing means, whereupon the liquid pressing fraction is returned to the process circuit.

11. Process as claimed in claim 10, wherein the solid pressing fraction is withdrawn from the process as a loose bed.

12. Process as claimed in claim 11, wherein the solid pressing fraction is mixed with other solids such as the oil cake from rape, soy or sunflowers, or wood waste.

13. Process as claimed in claim 10, wherein the solid pressing fraction is supplied to a pressing or pelletizing means.

14. Fuel, produced by a purification process as claimed in claim 11.

15. Fuel as claimed in claim 14, wherein the fuel is present in the form of pellets.

16. System for executing the process as claimed in claim 1, characterized by an agitated sedimentation tank (1) with a line (4, 5) for supplying purified biodiesel to the agitated sedimentation tank (1) as well as a conveyor means (6) for supplying cellulose-containing material to the agitated sedimentation tank (1), a drive (51) for a stirring mechanism (50) in the agitated sedimentation tank (1), a line (16, 20) to at least one static sedimentation tank (2, 3) and a valve (13) in the region of the bottom of the agitated sedimentation tank (1) via which solids can be discharged from it.

17. System as claimed in claim 16, wherein in the line (16, 20) to the static sedimentation tank (2, 3) a valve (17) is installed via which biodiesel can be returned via a line (18) to the agitated sedimentation tank (1).

18. System as claimed in claim 16, wherein in the region of the bottom of the static sedimentation tank (2, 3) there is a valve (31, 32) which is connected via a line (33, 34) to the agitated sedimentation tank (1).

19. System as claimed in claim 16, characterized by a mixing device (41) to which raw biodiesel is supplied via the line (4) and a valve (42) as well as a line (43) and the cellulose-containing material is supplied via the conveyor means (6), a valve (44) and a line (45), and by a line (46, 48) via which the mixture of biodiesel and cellulose-containing material emerging from the mixing device (41) is supplied to the agitated sedimentation tank (1).

20. System as claimed in claim 16, wherein the valve (13) is connected to a pressing device (14) in the region of the bottom of the agitated sedimentation tank (1) and whereon the pressing device is connected via a line (36) for the expressed biodiesel to the agitated sedimentation tank (1).

21. System as claimed in claim 20, wherein the pressing device (14) is connected via a buffer tank (52) to a pressing or pelletizing means (53).
